(19) United States
(12) Patent Application Publication
(10) Pub. No.: US 2004/0128000 A1
(43) Pub. Date: Jul. 1, 2004

(54) Recipe control system and method

(76) Inventors: Larry S. Phillips, Parma Heights, OH (US); Charles A. Greene, Elyria, OH (US)

Correspondence Address: Kenneth W. Fafrak, Renner, Otto, Boisselle & Sklar, LLP, Nineteenth Floor, 1621 Euclid Avenue, Cleveland, OH, 44115, US

(21) Appl. No.: 10/365,945

(22) Filed: Feb. 12, 2003

Related U.S. Application Data
(60) Provisional application No. 60/436,511, filed on Dec. 26, 2002.

(51) Int. Cl. G05B 15/00; G05B 11/01; G05B 19/42; G05D 7/00; G05D 11/00

(52) U.S. Cl. 700/25; 700/1; 700/86; 700/19

(57) ABSTRACT

A system and method for controlling a process is disclosed. A grid is displayed on a screen, wherein the grid includes at least one row and a plurality of columns, and the intersection of each row with each column forms a sector. Each row is associated with at least one I/O point, and each column is associated with a time interval. Setpoints are entered into each sector and a plurality of time interval signals are generated by a timer. The I/O points are set to a setpoint in a selected sector, wherein the sector is selected based on the row associated with the I/O point, the time interval associated with the sector and the time interval signal.

### CROSS REFERENCE TO RELATED APPLICATIONS

This Application claims priority from U.S. Provisional Application Serial No. 60/436,511 filed Dec. 26, 2002, which is incorporated herein by reference.

### TECHNICAL FIELD

The present invention relates generally to recipe control, recipe control system and method. The invention also relates to a graphical display or interface with which, and a system and method by which a worker can set various recipes, control functions, and the like for automated equipment and processes in which automated equipment is used.

### BACKGROUND OF THE INVENTION

Many processes, recipes and the like in automated equipment systems and the methods in which they are used must be set manually by the equipment operator. As but one example, in the spray coating or spray painting field the equipment operator typically would operate the equipment to turn on an applicator to pain or coat an object and later would turn off that applicator. The operator also may have to take separate steps to cause paint to fill the flow line of a spray gun system and later may take separate steps to purge the flow line, e.g., to clean it, by directing a flow of solvent through the flow line and later air to dry or to evaporate solvent in the flow line or flow path prior to shut down and/or prior to providing another paint, paint color, etc., to the flow line. These steps usually are taken at specific times or at approximate times during the course of the use of the automated equipment and/or in the process of applying paint, another coating, or otherwise processing a given object, part or the like. The time and labor required to carry out such steps may be substantial relative to the overall time required to process a given part, e.g., to paint it. Also, the time to carry out a given step and/or to initiate a step can vary as the equipment operator becomes fatigued, as different equipment operators have different reaction speeds, etc. The increased time and variations in time can increase the cost of processing parts using the automated equipment and/or may reduce consistency and uniformity of the processing.

Thus, there is a need in the art to facilitate setting various functions, recipes and the like in automated equipment. There also is a need to maintain uniformity and consistency of a processing carried out by automated equipment.

### SUMMARY OF THE INVENTION

With the above in mind, then, an aspect of the present invention is a computer controller that includes a display interface; a grid displayed on the display interface, wherein the grid includes at least one row and a plurality of columns; a plurality of sectors on the grid, wherein each sector is formed by the intersection of the at least one row with each column; at least one I/O point, wherein the at least one I/O point is associated with the at least one row; a processor; wherein the processor is operatively coupled to the at least one I/O point and to the display interface; a timer for generating a plurality of time intervals, wherein each time interval is associated with a column; a plurality of data representing setpoints for the at least one I/O point, each setpoint being entered in a respective sector; and a computer program executed by the processor to cause the computer controller to sequentially set the at least one I/O point to the value in a selected sector, wherein the sector is selected based on the row associated with the at least one I/O point, the time interval associated with the sector and the time interval generated by the timer.

Another aspect of the invention relates to a method for controlling a process, including the steps of displaying a grid, wherein the grid includes at least one row and a plurality of columns, and the intersection of the at least one row with each column forms a sector; associating the at least one row with at least one I/O point; associating each column with a time interval; entering a setpoint in each sector; generating a plurality of time interval signals; and setting the at least one I/O point to the setpoint in a selected sector, wherein the sector is selected based on the row associated with the at least one I/O point, the time interval associated with the sector and the time interval signal.

Another aspect of the invention relates to a system for controlling a coating process, which includes at least one applicator for applying a coating, wherein the applicator is operatively coupled to an I/O point; at least one supply source used by the applicator; at least one control valve for selecting the at least one supply source used by the applicator, wherein the control valve is operatively coupled to at least one I/O point; and a computer controller. The computer controller includes a display interface; a grid displayed on the display interface, wherein the grid includes a plurality of rows and a plurality of columns; a plurality of sectors on the grid, wherein each sector is formed by the intersection of each row with each column; a plurality of I/O points, wherein each I/O point is associated with a row; a processor; wherein the processor is operatively coupled to the plurality of I/O points and to the display interface; a timer for generating a plurality of time intervals, wherein each time interval is associated with a column; a plurality of data representing setpoints for the plurality of I/O points, each setpoint being entered in a respective sector; and a computer program executed by the processor to cause the computer controller to sequentially set each I/O point to the value in a selected sector, wherein the sector is selected based on the row associated with each I/O point, the time interval associated with the sector and the time interval generated by the timer.

Other aspects, features, and advantages of the invention will become apparent from the following detailed description. It should be understood, however, that the detailed description and specific examples, while indicating several embodiments of the present invention, are given by way of illustration only and various modifications may naturally be performed without deviating from the present invention.

### BRIEF DESCRIPTION OF THE DRAWINGS

FIG. 1 is a schematic environmental view of a coating system utilizing an operator interface in accordance with the invention.

FIG. 2 is a block diagram of a computer controller used to implement an operator interface in accordance with an embodiment of the invention.

FIG. 3A illustrates an operator interface during setup mode in accordance with an embodiment of the invention.

FIG. 3B illustrates the operator interface of FIG. 3A during run mode.

FIG. 3C illustrates the operator interface of FIG. 3A during run mode.

FIG. 3D illustrates the operator interface of FIG. 3A during run mode.

FIG. 4A is a flow chart illustrating an exemplary setup procedure or method of implementing an operator interface in accordance with the invention.

FIG. 4B is a flow chart illustrating an exemplary run time procedure or method of executing an operator interface in accordance with the present invention.

### DESCRIPTION

The following description of the invention refers to the attached drawings, wherein like reference numerals designate like elements throughout in the several figures.

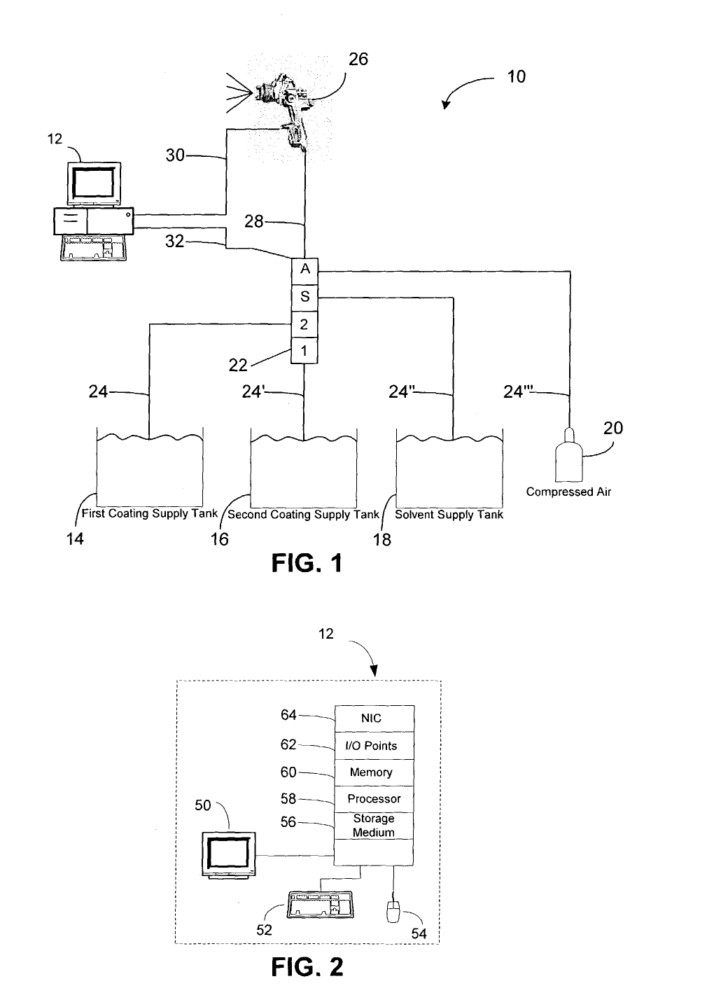

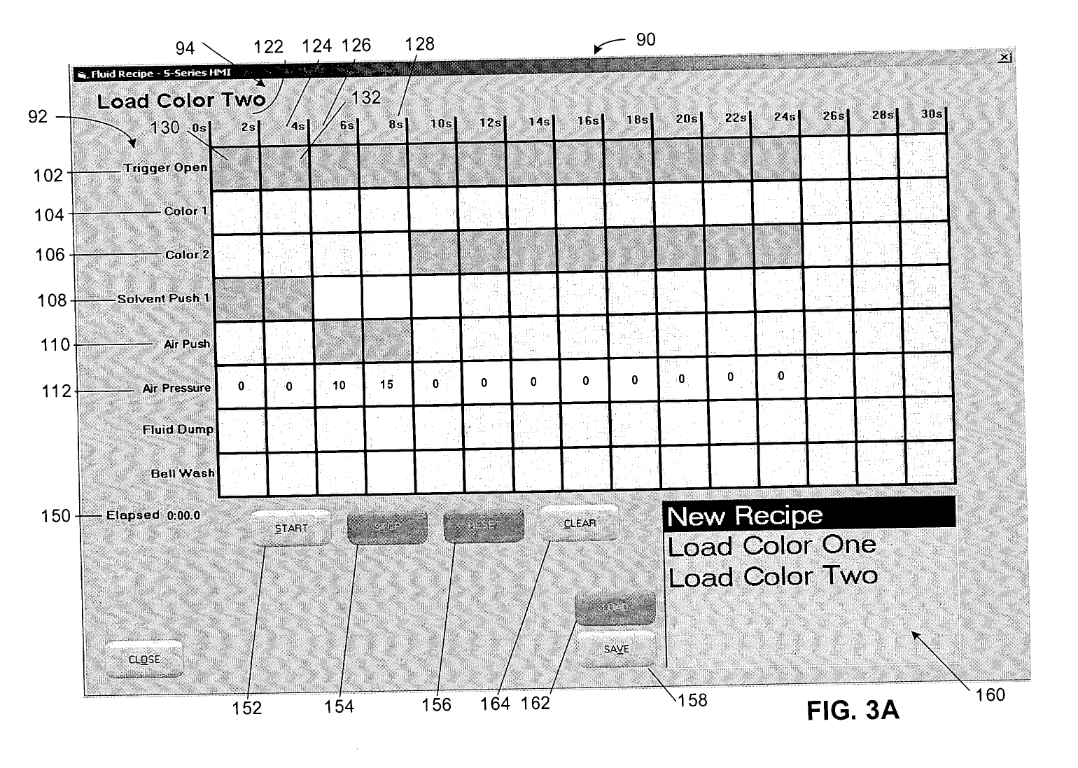

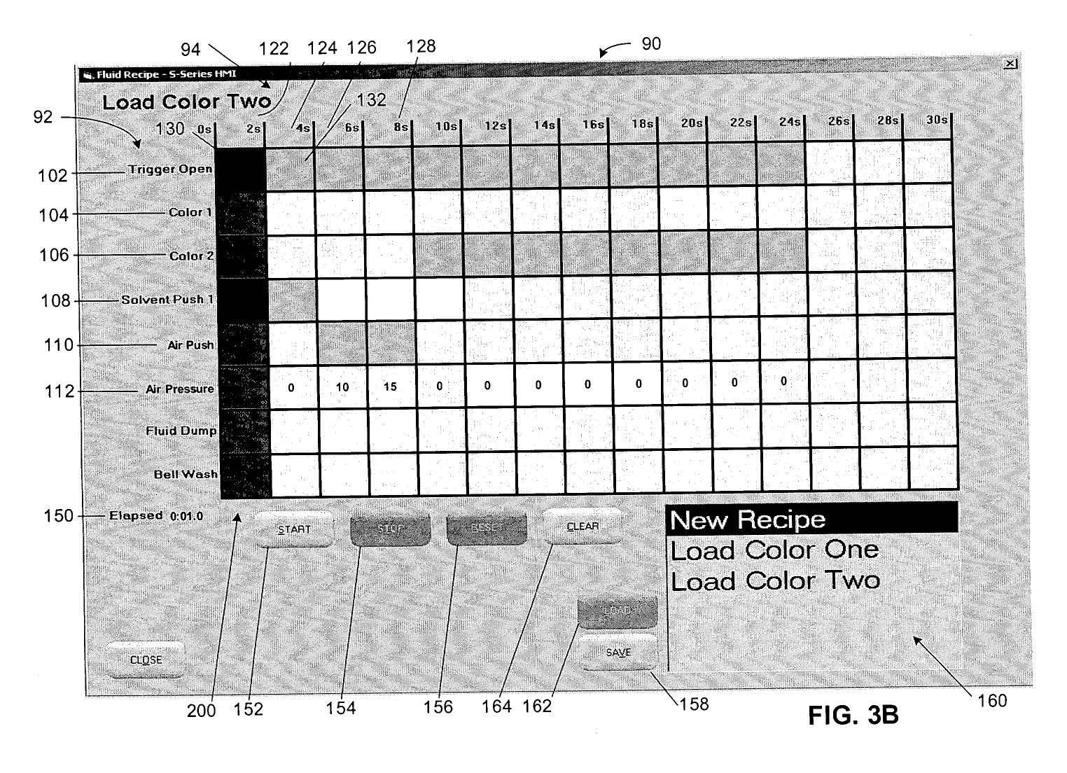

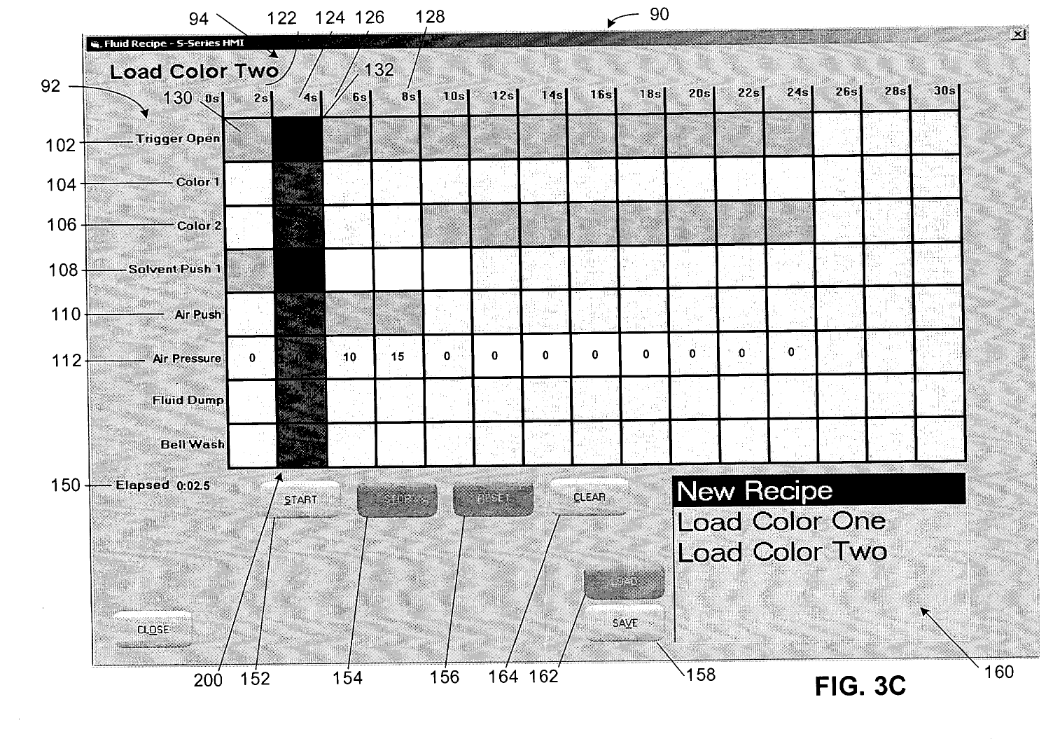

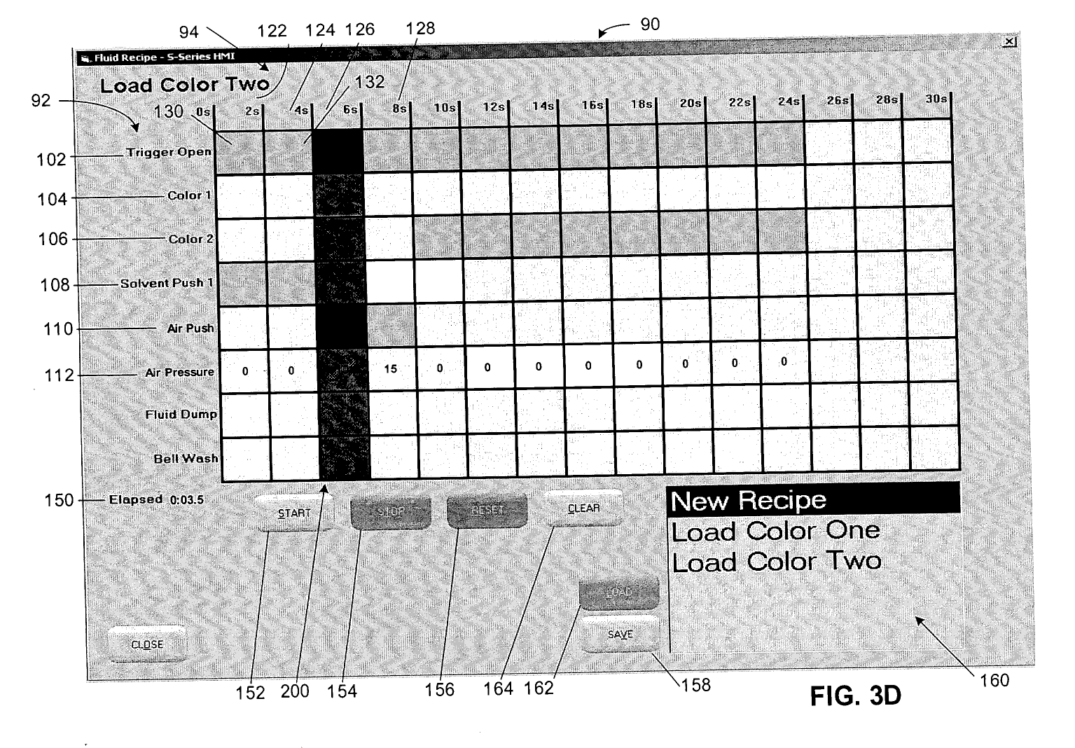

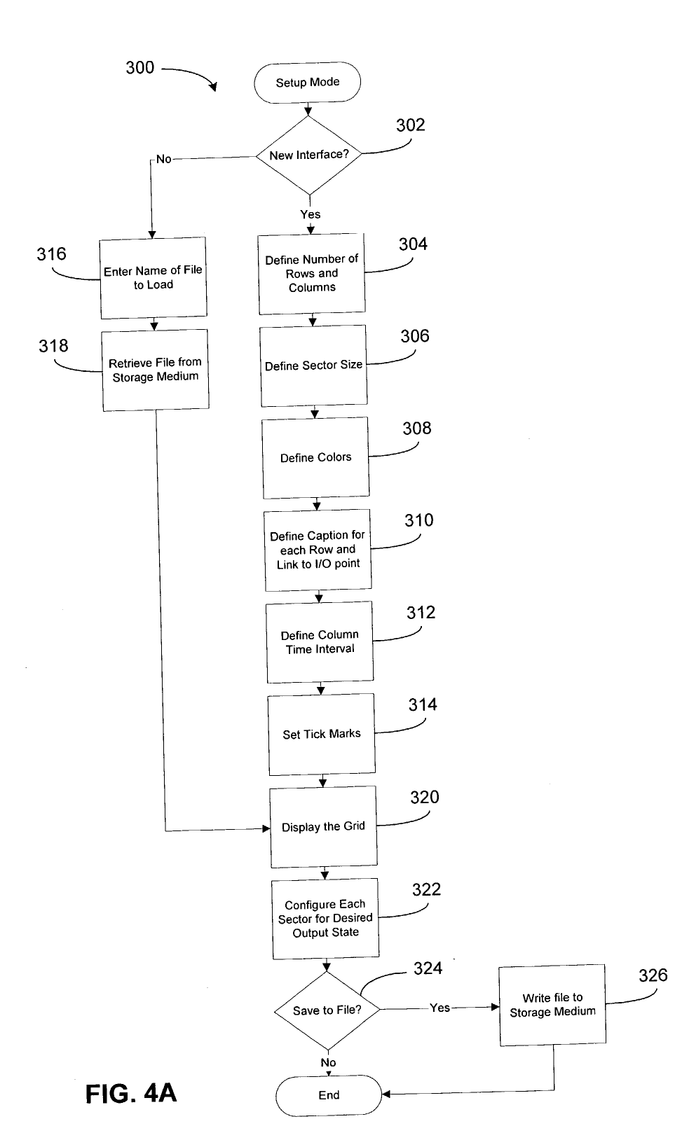

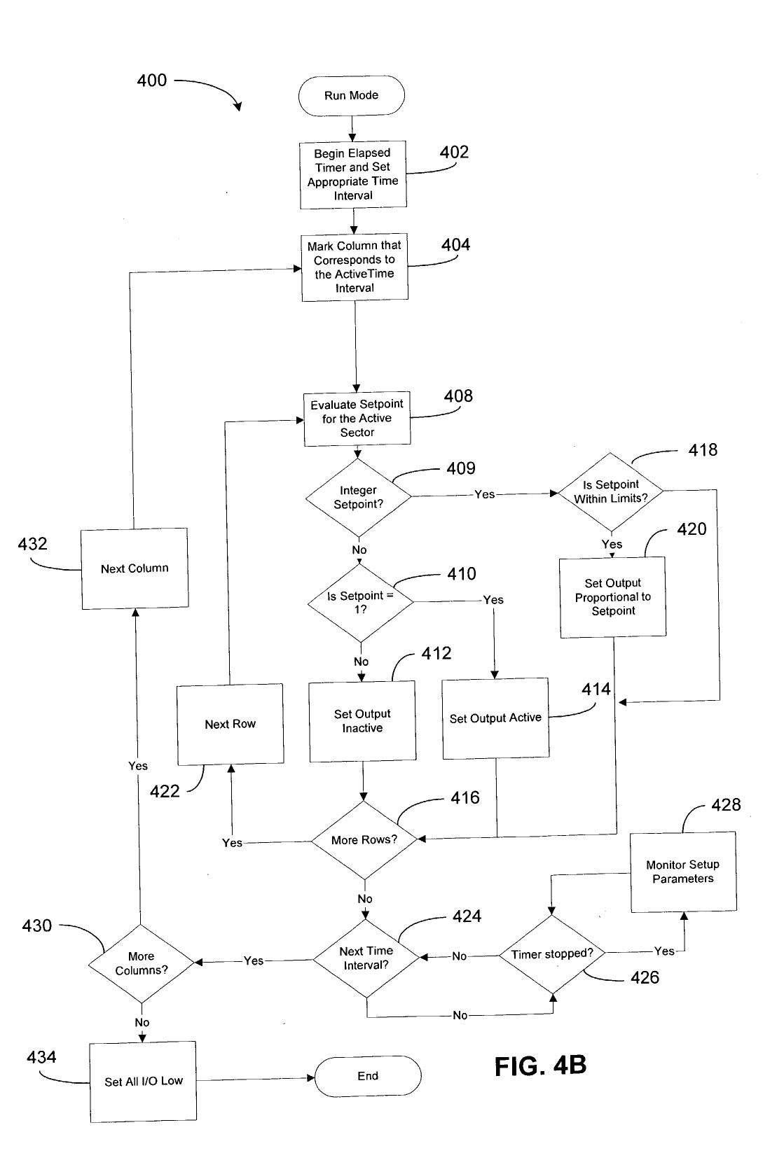

Referring to FIG. 1, an environmental view of a coating system 10 is illustrated. The coating system 10 includes a computer controller 12, which is used to set up and control the coating system 10, for example, to select coating material, e.g., paint, to control coating processes, to control cleaning functions, and/or to provide other control operations or other aspects of the coating system. The computer controller 12 provides a display grid or “operator interface” to show several functions, parameters, etc. associated with the coating system 10 and coating process in which it is used. Using the operator interface and the information it presents, an operator may select, change, adjust, and/or otherwise set a determined operation of the coating system 10. In addition, the operator interface provides functional control capabilities with respect to a continuing parameter, e.g., time. The continuing parameter may continue uniformly, in equal or unequal steps, or in some other fashion. The continuing parameter may be other than time, one example being progression in a given process. The operator interface and its use and operation are described further with respect to FIGS. 3 and 4.

Continuing to refer to FIG. 1, the coating system 10 also includes a first coating supply tank 14, which provides a first coating material; a second coating supply tank 16, which provides a second coating material; and a solvent supply tank 18, which provides a cleaning material. In addition, a compressed air source 20, such as an air compressor, provides compressed air to purge the coating material and/or cleaning material from the coating system 10 and/or to dry the lines. The coating supply tanks 14, 16, solvent supply tank 18 and compressed air source 20 are connected to a control valve 22 through a first, second, third and fourth supply line 24, 24′, 24″, 24′″ respectively. An applicator 26, such as a paint spray gun, for example, is connected to the control valve 22 through a delivery line 28. The computer controller 12 is electrically connected to the applicator 26 through a first electrical connection 30. Similarly, the computer controller 12 is electrically connected to the control valve 22 through a second electrical connection 32. The electrical connections may be, for example, a digital I/O (input/output) point, or alternatively, and depending on the equipment connected to the computer controller, the electrical connection may be an analog I/O point, such as a 4 to 20 mA signal or a 0 to 10 V signal, for example. Another example of an electrical connection may be a communications link, such as a network interface. It is noted that while the first and second electrical connections 30, 32 are shown as a single connection, there may be multiple connections within each electrical connection. It should be appreciated that while only two coating tanks and one solvent tank are illustrated, more or fewer tanks containing respective coatings, solvents and/or other materials may be implemented and such systems are contemplated to be within the scope of the invention. Similarly, while only two electrical connections are shown, more or fewer electrical connections may be implemented.

With continuing reference to FIG. 1, the operation of the coating system 10 now will be briefly described. For the purpose of this description, it will be assumed the coating system 10 initially is clean. The computer controller 12, through the second electrical connection 32, instructs the control valve 22 to select a source for the coating material. The source may be, for example, the first coating supply tank 14 or the second coating supply tank 16. Next, the computer controller 12, through the first electrical connection 30, instructs the applicator 26 to begin the application of the coating material. In response, the applicator 26 opens a spray valve (not shown) and the coating material, after traveling through the respective supply line, control valve 22, and delivery line 28, is expelled from the applicator 26. The coating material is expelled from the applicator by the aid of a pump (not shown) and/or gravity, for example.

Once the coating operation is complete, the computer controller 12, through the first electrical connection 30, instructs the applicator 26 to close the spray valve, thus stopping the flow of coating material. Generally, if the coating system 10 will not be used for a significant period of time, the coating material in the control valve 22, the delivery line 28 and the applicator 26 must be removed to prevent clogging of the respective components. To remove the coating material, a cleaning step is performed by the computer controller 12. This step is similar to the coating application described above, except a solvent or other cleaning solution is selected as the source instead of a coating material.

For example, to clean the coating system 10 the computer controller 12, through the second electrical connection 32, instructs the control valve 22 to select the solvent supply tank 18. Next, the computer controller 12, through the first electrical connection 30, instructs the applicator 26 to open the spray valve (not shown) and the solvent, after traveling through the respective supply line, control valve 22, and delivery line 28, is expelled from the applicator 26. After a sufficient period of time (which will vary depending on the length of the lines), the computer controller 12 instructs the control valve 22 to deselect the solvent supply tank and to select the compressed air source 20. Thus, only compressed air will be traveling through the control valve 22, supply line 28, and applicator 26. The compressed air is expelled from the applicator 26 to remove residual solvent and/or to dry the lines. After a sufficient period of time (again, which will vary depending on the length of the lines), the computer controller 12, through the first electrical connection 30, instructs the applicator 26 to close the spray valve, thus completing the cleaning process.

It should be appreciated that as the number of coating materials and solvents increase, the setup and control of the coating system 10 can become complex. Moreover, there are numerous functions associated with the coating process that have not been discussed, e.g., air pressure, stroke speed, stroke length, etc. The computer controller 12 can reduce the burden placed on operators by controlling various aspects of the coating operation.

Referring to FIG. 2, the computer controller 12 will be described in more detail. The coating system 10 includes a computer controller 12 for entry, display and control of system parameters, e.g., process related variables. Typically, the computer controller 12 is based on an industrial workstation. As is well known by those skilled in the art, an industrial workstation is a computer designed to withstand the harsh environments found in industrial applications. A non-industrial workstation (e.g. standard personal computer) may be used, however, if sufficient protection from the industrial environment is provided. Other controllers also or alternatively may be used.

The computer controller 12 includes a display 50 for viewing system information. The technology used in the display is not critical and may be any type currently available, such as a flat panel liquid crystal display (LCD) or a cathode ray tube (CRT) display, or any display subsequently developed. A keyboard 52 and pointing device 54 may be used for data entry, data display, screen navigation, etc. The keyboard 52 and pointing device 54 may be separate from the computer controller 12 or they may be integral to it. A computer mouse or other device that points to or otherwise identifies a location, action, etc., e.g., by a point and click method or some other method, are examples of a pointing device. Alternatively, a touch screen (not shown) may be used in place of the keyboard 52 and pointing device 54. A touch screen is well known by those skilled in the art and will not be described in detail herein. In one example, a touch screen has a thin transparent membrane over the viewing area of the display 50. Touching the viewing area sends a signal to the computer controller 12 indicative of the location touched on the screen. The computer controller 12 may equate the signal in a manner equivalent to a pointing device and act accordingly. For example, an object on the display 50 may be designated in software as having a particular function, e.g., view a different screen. Touching the object may have the same effect as directing the pointing device 54 over the object and selecting the object with the pointing device, e.g., by clicking a mouse. Touch screens may be beneficial when the available space for a keyboard 52 and/or a pointing device 54 is limited.

Included in the computer controller 12 is a storage medium 56 for storing information, such as application data, screen information, programs, etc. The storage medium 56 may be permanently fixed within the computer controller 12 or it may be removable. A processor 58 combined with a memory 60 and the storage medium 56 execute programs to perform various functions, such as recipe management, position control, screen display, system setup, etc.

The computer controller 12 may also include I/O points 62 to provide digital and/or analog I/O capabilities. The I/O points 62 may be used to send and receive feedback signals from various devices in the system. For example, a digital output signal may be used to initiate a spray command to a spray valve solenoid, and a digital input may be used to receive confirmation that the spray valve has opened. In a similar fashion, an analog output may be used to transmit a 4-20 mA air pressure reference to a control valve, while an analog input is used to receive a 4-20 mA pressure feedback signal from a pressure sensor. Alternatively the analog signals may be voltage signals, such as a 0-10 VDC signal. These signal formats are, of course, exemplary and it will be appreciated that others may be used.

A network interface card (NIC) 64 allows the computer controller 12 to communicate with several components within the coating system 10. The type of NIC 64 used may depend on the communication protocols available on other components present within the coating system 10. For example, the applicator 26 may not have Ethernet capabilities, thus suggesting that an Ethernet NIC is not the best choice. Multiple NIC's 64, however, may be used to construct a network to meet the needs of the individual components. Many electronic devices, such as sensors, actuators, etc. have network capabilities built in to them and thus it is possible to construct a coating system 10 wherein a majority, if not all of the devices, can communicate with the computer controller 12 via the NIC 64. While the NIC 64 provides an easy and quick method to communicate with devices in the coating system 10, it is noted that the NIC 64 is optional and the system may be constructed without a NIC 64. For example, the coating system 10 may use only analog and digital I/O to control the system, without direct communications to any device.

To facilitate the setup and operation of automated machinery, operator interfaces are implemented using various software packages, e.g., Visual Basic (a registered trademark of the Microsoft Corporation), iFIX (a registered Trademark of Intellution, Inc.), InTouch (a registered trademark of the WonderWare Corporation), etc. The operator interface can be implemented using the computer controller 12 described above, for example.

Referring to FIG. 3A, an operator interface 90 in accordance with an embodiment of the invention is illustrated. The operator interface 90 is constructed in a grid like fashion, e.g., rows and columns of data. Each row 92 refers to an I/O point or actuator on a machine or device, and each column 94 refers to a time interval, e.g., a block of time. Using the coating system 10 as an example, the first row 102 refers to the “Trigger Open” setting (e.g., control of the applicator 26), the second row 104 refers to the “Color 1” setting (e.g., the first coating supply tank), the third row 106 refers to “Color 2” setting (e.g., the second coating supply tank), the fourth row 108 refers to the “Solvent Push 1” setting (e.g., the solvent supply tank), the fifth row 110 refers to the “Air Push” setting (e.g., compressed air), and the sixth row 112 refers to an “Air Pressure” setting (e.g. an integer setpoint for control of the compressed air pressure).

In a similar manner, the first column 122 refers to a first time interval, which begins at zero seconds and continues until two seconds have elapsed (two seconds total). A second column 124 refers to a second time interval which begins at two seconds and continues until an additional two seconds have elapsed (four seconds total). A third column 126 refers to a third time interval which begins at four seconds and continues until additional two seconds have elapsed (six seconds total), and so on. Generation of each time interval is discussed below. It is noted that while specific I/O points and time intervals have been described, the I/O points and time intervals are merely exemplary and other I/O points and/or time intervals can be used without departing from the scope of the invention. Tick marks 128 indicate the value of each time interval.

As mentioned above, the rows 92 of the operator interface 90 are linked or associated with actuators on an automated machine or system, such as the coating system 10, for example. In one embodiment, the link is through digital I/O points. For example, the first row 102 (Trigger Open) is linked to an I/O point 62 that is connected to the first electrical connection 30, which is electrically connected to the applicator 26. The second row 104, third row 106, fourth row 108, and fifth row 110 are linked to I/O points 62 connected to the second electrical connection 32, which is electrically connected to the control valve 22. Alternatively, the link may be through an analog I/O point. For example, the sixth row 112 (Air Pressure) is connected to an analog I/O point which sends an analog signal to a pressure valve (not shown). In another embodiment, the link is through the NIC 64. For example, a communication network is established between the computer controller 12 and a particular device (e.g., the actuator 26) and commands are transmitted from the computer controller 12 to the device over the network connection. Thus, by manipulating a value associated with a row, the computer controller 12 can control specific operations of the coating system 10.

The intersection of each row 92 with each column 94 forms a sector. For example, the intersection of the first row 102 and the first column 122 forms a first sector 130. Similarly, the intersection of the first row 102 with the second column 124 forms a second sector 132. Accordingly, the number of sectors in the operator interface 90 is equal to the number of rows times the number of columns. Each sector defines a setpoint for a respective I/O point or actuator with respect to a particular time interval. For example, the first sector 130 has a setpoint associated with the “Trigger Open” function of the coating machine, where the setpoint is active during the first time interval, e.g., 0-2 seconds. The second sector 132 has a setpoint associated with the “Trigger Open” function of the coating machine, where the setpoint is active during the second time interval, e.g., 2-4 seconds. In one embodiment, each sector contains a boolean setpoint, e.g., 0 or 1. In another embodiment, each sector contains an integer or “analog” setpoint. In another embodiment, there is a mixture of boolean sectors and analog sectors, e.g., the sectors of certain rows are associated with boolean setpoints and sectors of other rows are associated with integer setpoints.

Boolean data can be entered into each sector by selecting or “clicking” on the sector with the pointing device 54, such as a mouse, for example. Each time the sector is selected, it will toggle its setting. For example, if a sector has a setpoint of 0 and the sector is selected, the value in the sector will toggle to 1. Similarly, if a sector has a setpoint of 1 and the sector is selected, the value in the sector will toggle to 0. In addition, boolean setpoints as well as integer/analog setpoints may be entered through a numeric pop-up window or keyboard, for example. Alternatively, integer setpoints may derive the actual setpoint from a separate analog slider. For example, a setpoint of “1” would indicate to the computer controller 12 to derive a setpoint from a first analog slider (not shown) on the operator interface 90. A setpoint of “2” would indicate to the computer controller 12 to derive a setpoint from a second analog slider (not shown) on the operator interface 90, etc.

In addition, it may be desirable to prevent two or more actions from being active during the same time interval, e.g., selecting solvent and paint at the same time or selecting two colors at the same time. The operator interface 90 can be configured to “lock out” certain sectors (e.g., force a setpoint of 0) if other sectors have a setpoint of 1 during the same time interval. For example, if the second row 104 (Color 1) has a setpoint of 1 during the first time interval, then the third row 106 (Color 2) will be inhibited from having a setpoint of 1 during the first time interval. Alternatively, sectors can be made mutually exclusive or mutually inclusive with other sectors.

To assist in determining the setting of a sector, the appearance of the sector can change depending on the value entered in the sector. For example, a sector with a setpoint of 0 will appear with a white background, while a sector with a setpoint of 1 will appear with a gray background. This feature is illustrated by referring to the operator interface 90 of FIG. 3A. The first row 102 (Trigger Open) has a setpoint of 1 for the first twelve time intervals (gray sector; 0-24 seconds), and a value of 0 for the next three time intervals (white sector; 24-30 seconds). This concept also may be applied to integer setpoints. For example, setpoints in the range of 0-10 may have a yellow sector and setpoints in the range of 11-20 may have a green sector. Additionally, the integer value may be displayed in the sector, as can be seen in the sixth row 112 of the operator interface 90.

An elapsed timer 150 generates the time interval associated with each column 94. The elapsed timer 150 is controlled through buttons or “touch zones” implemented within the operator interface 90. For example, the elapsed timer 150 is activated by actuating a start button 152, e.g., selecting and clicking on the start button 152. After the elapsed timer 150 is activated, the timer begins keeping the elapsed time. In addition, the elapsed timer 150 flags or sets a time interval as active, e.g., high or logic “1”, if the start time of the time interval is less than or equal to the elapsed time and the end time of the time interval is greater than the elapsed time. Time intervals that do not meet the criteria are set as inactive, e.g., low or logic “0”. The elapsed timer 150 continues timing until all defined time intervals have elapsed or the timer is stopped by actuating a stop button 154. If the stop button is actuated, then the elapsed timer 150 stops timing and all I/O points are turned off (e.g., disabled). The elapsed timer 150 may be restarted by actuating the start button 152, at which point the elapsed timer 150 continues timing and the I/O points are actuated based on the settings entered in the operator interface 90. Alternatively, the elapsed timer 150 may be reset by actuating a reset button 156, which causes the computer controller 12 to set the elapsed timer 150 to zero, for example.

The time intervals set by the elapsed timer 150 may be operator adjustable or the time intervals may be fixed (e.g., not adjustable). For example, an operator may define the length of the time interval depending on the requirements of a system. In one instance each time interval may be two seconds long. In another instance each time interval may be thirty seconds long. In one embodiment, all time intervals are equal in time. In another embodiment, one time interval may have a different time period from another time interval.

Setpoint entries made into the operator interface 90 as well as the characteristics of the operator interface, e.g., the number of rows, columns, caption settings, etc. can be stored to and retrieved from the storage medium 56. Storage and retrieval of setpoints is well known in the art and generally is referred to as recipe management or recipe control. Setpoint entries and operator interface characteristics are saved to the storage medium 56 by actuating the save button 158 and selecting a name under which to store the setpoints. The “name” commonly is referred to as the recipe or recipe name. The save button 158 instructs the computer controller 12 to write the current setpoints in each sector and the operator interface characteristics to the storage medium 56. A list of existing recipes stored on the storage medium 56 is displayed in the recipe window 160. As a recipe is saved to the storage medium 56, the operator may select an existing recipe, e.g., use the pointing device 54 to select a recipe in the recipe window 160, or the operator may enter a new recipe name, e.g., use the keyboard 52 to type a new name. If an existing recipe is selected, the old information in the recipe is overwritten by the new information. If a new recipe is created, the information is stored under the new receipe name and the new recipe appears in the recipe window 160.

A recipe may be loaded from the storage medium 56 by selecting a recipe name from the recipe window 160 and actuating the load button 162. The load button 162 instructs the computer controller 12 to retrieve the setpoints and operator interface characteristics from the “selected recipe” and create the operator interface based on the retrieved setpoints and characteristics. After the recipe has loaded, the loaded setpoints become the current setpoints and are reflected in the sectors of the operator interface 90. If an operator wishes to clear the settings in all sectors, the sectors can be reset by actuating a clear button 164, which causes the computer controller 12 to set all sectors to 0, for example.

Referring now to FIGS. 3B-3D, the operator interface 90 is illustrated in “run mode”. Although not shown, the operation mode of the operator interface may be indicated by known methods, such as displaying a message on the operator interface 90 (e.g., run mode, setup mode, etc.) or changing the color of an indicator on the operator interface, for example. Run mode is activated by actuating the start button 152, which also actives the elapsed timer 150. The elapsed timer 150, once activated, keeps the actual elapsed time that the operator interface 90 has been in run mode. Furthermore, the elapsed timer 150, based on specified criteria, sets time intervals as being active or inactive. As discussed previously, an active time interval is defined as a time interval that has a start time less than or equal to the elapsed time and an end time greater than the elapsed time. The active time interval is indicated on the operator interface 90 by the interval bar 200. Alternative methods of indicating the active time interval may be used, such as, for example, changing the font color and/or font size of the column heading associated with the time interval, scrolling the columns 94 through an “active window”, or providing a moving pointer that points to the active time interval.

The interval bar 200 indicates the active time interval by changing the appearance of a column 94 associated with the active time interval. For example, when the elapsed timer 150 is started, the first time interval that satisfies the active time interval criteria is the 0-2 second time interval, which is associated with the first column 122. The interval bar 200, by changing the appearance of the first column 122, indicates that the active time interval is the 0-2 second time interval. Furthermore, the computer controller 12, through I/O or through a communications link, for example, instructs actuators on the coating system 10 to follow the setpoints associated with each sector in the active time interval.

For example, when an operator actuates the start button 152 of the operator interface 90, the elapsed timer 150 begins timing (starting at zero) and sets the first time interval as being active. Using the above described criteria, the first time interval is the 0-2 second time interval. The interval bar 200 is placed on the first column 122, e.g., the 0-2 second column, thus indicating the active time interval (FIG. 3B). During this time interval, the computer controller 12 instructs the coating system 10 to follow the setpoints in each sector of the active time interval. Referring to the setpoints shown on the operator interface 90 for the first time interval, the I/O or actuator associated with the “Trigger Open” and “Solvent Push 1” are set to logic 1 while all other I/O points are set to logic 0. The I/O remains in this state for the remainder of the time interval. When the elapsed time is greater than the end time of the first time interval, the first time interval is set inactive and the next time interval, e.g., 2-4 seconds, is set as active (FIG. 3C). In addition, the interval bar moves from the first column 122 (the first time interval) to the second column 124 (the second time interval), thus indicating the second time interval is active. As can be seen from the operator interface 90, the setpoints in the second time interval is unchanged from the first time interval, and thus each I/O point remains unchanged. The I/O remains in this state for the remainder of the second time interval. When the elapsed time is greater than the end time of the second time interval, the second time interval is set inactive and the next time interval, e.g., 4-6 seconds, is set as active (FIG. 3D), and the interval bar moves from the second column 124 to the third column 126 (the third time interval). Referring to the setpoints shown on the operator interface 90 for the third time interval, the I/O or actuator associated with the “Trigger Open” and “Air Push” are set to logic 1 while all other I/O are set to logic 0. Thus, at the transition from the second time interval to the third time interval, the state of the “Solvent push 1” I/O is changed from logic 1 to logic 0 and the state of the “Air Push” I/O is changed from logic 0 to logic 1. Furthermore, the “Air Pressure” setpoint is set to 10% of the maximum value. All other I/O points are set to logic 0. This sequence continues until all of the defined time intervals have expired or until the stop button 154 is actuated.

At any time during the run mode of operation, an operator may stop the elapsed timer 150 by actuating the stop button 154. The stop button 154 will stop the elapsed timer at its current time and places the operator interface 90 in setup mode. During setup mode, the operator may modify setpoints on the operator interface. The operator may restart the elapsed timer 150 by actuating the start button 152, at which point run mode resumes and the elapsed timer 150 continues timing from the point it was stopped. Alternatively, the operator may reset the elapsed timer 150 by actuating the reset button 156, which will set the elapsed timer 150 back to zero. In one embodiment the operator interface 90 is configured to prevent modification of setpoints while the operator interface is in the run mode. In another embodiment, the operator interface is configured to allow modification of setpoints while the operator interface is in run mode.

Referring now to FIG. 4A and FIG. 4B, flow diagrams illustrating the above steps are shown. FIG. 4A illustrates a setup mode flow chart 300 for the operator interface 90, while FIG. 4B illustrates a run mode flow chart 400 for the operator interface 90.

Beginning at step 302 of the setup mode flow chart 300, the computer controller 12, based on user input, determines whether a new operator interface will be created or an existing operator interface will be loaded from the storage medium 56. If an operator interface will be created, then the user defines the number of rows 92 and columns 94 in the operator interface 90 as shown in step 304. For example, a system may have three I/O points that require control from the computer controller 12, and these I/O points each may require six different settings throughout one cycle of a process. Assuming that each I/O point requires independent control from the other I/O points, then the operator interface 90 requires at least three rows and at least six columns (e.g., one row per I/O point and 1 column per setting). Next at step 306, the user defines the sector size, e.g., the height and width of each sector. Generally, the sector size should be large enough to allow easy viewing and manipulation of a setpoint, but not so large as to consume a considerable portion of the viewing area of the display interface 50. The sector size may be entered in pixels (e.g., 50 pixels high and 75 pixels wide) or actual engineering units (e.g., 1 centimeter high and 1.5 centimeters wide).

At step 308, the colors of the various objects in the display area are defined. For example, text may be defined as having black lettering, sectors having a logic 0 setpoint may be defined as having a white background, while sectors having a logic 1 setpoint may be defined as having a gray background. Next at step 310, the caption for each row and its associated I/O and/or actuator are defined. For example, the caption for the first row 102 may be defined as “Trigger Open”. In addition, the first row 102 is associated with an I/O point or actuator connected to the Trigger Open function of the machine, e.g., an I/O point connected to the first electrical connection 30, which in turn is connected to an actuator (not shown) mounted on the applicator 26. At step 312 the column time interval is defined. The column time interval determines the length of time that each time interval will remain active. For example, if a two second time interval is defined, then each time interval will be active for a two second block of time and each column 94 will represent two seconds. If a ten second time interval is defined, then each time interval will be active for a ten second block of time and each column will represent ten seconds. At step 314, tick marks 128 indicating each particular time interval are displayed above the column time interval. Depending on the total time interval of the grid, the tick marks 128 may be placed above each time interval or they may be placed at a multiple of the number of time intervals, e.g., every other time interval. At step 320 the computer controller 12 draws the operator interface based on the information entered in steps 304 through 314. Alternatively, the computer may redraw the grid when any change is entered into the system. For example, if an operator is defining the number of rows and columns at step 304, the computer controller 12 may redraw the grid upon the entry of the number of rows and columns instead of waiting for all of the remaining data (e.g., steps 306-314) to be entered.

Referring briefly back to step 302, if the computer controller 12, based on user input, determines that an existing operator interface will be displayed, then at step 316 the name of the operator interface is entered. The name is entered by selecting the name of the from the recipe display window 160 with the pointing device 54 or by typing the name using the keyboard 52, for example. At step 318 the computer controller 12 retrieves the respective data from the storage medium 56 and proceeds to step 320, where the computer controller 12 draws the operator interface based on the information retrieved from the storage medium 56.

At step 322, the user may change a setpoint entered in each sector of the operator interface 90. For example, the user may toggle the state of any boolean setpoint in a sector by selecting the sector with the pointing device 54 and clicking on the sector. Clicking on the sector has the effect of toggling the current value of that sector, e.g., changing a 0 to a 1 or a 1 to a 0. Alternatively, the user may enter integer data and/or boolean data through the keyboard. Moving to step 324, the user may save the file to the storage medium 56 or elect not to save the file. If the file is not saved, then the setup routine is complete. If the file is saved to the storage medium 56, then the data is written to the storage medium at step 326. After the file is written to the storage medium, the setup routine is complete.

Referring now to FIG. 4B, the run mode flowchart 400 is illustrated. Beginning at step 402, the elapsed timer 150 is started, which initiates the run mode of operation. As was discussed previously, the elapsed timer 150 is started by actuating the start button 152. Once started, the elapsed timer 150 keeps the elapsed time that the operator interface 90 has been in run mode. In addition, the elapsed timer 150 sets the active time interval based on specific criteria. For example, a time interval is marked active if the time interval's start time is less than or equal to the elapsed time and the time interval's end time is greater than the elapsed time. Moving to step 404, the column corresponding to the active time interval is marked, e.g. highlighted or indicated by a visual means.

At step 408, the setpoint in the active sector is evaluated. The active sector is determined from the intersection of the active time interval, e.g., the column corresponding to the active time interval as determined from the elapsed timer 150, and the current row being evaluated, e.g., the first row 102. For example, if the first time interval is active (0-2 seconds) and the current row is the first row 102, then the active sector is the first sector 130 (the intersection of the first row and the first column). At step 409, the computer controller 12 determines whether the setpoint is a boolean setpoint or an integer setpoint. If the value in the active sector is a boolean setpoint, then the computer controller moves to step 410 and determines whether the boolean setpoint is high or low. If the value in the active sector is low, e.g., logic 0, then an I/O point or actuator corresponding to the current row is set inactive (e.g., disabled) as shown in step 412, and the computer controller moves to step 420. If, on the other hand, the value in the active sector is high, e.g., logic 1, then an I/O point or actuator corresponding to the current row is set active (e.g., enabled) as shown in step 414, and the computer controller moves to step 420.

Referring back to step 409, if the setpoint is an integer setpoint, then the computer controller moves to step 418 and the integer setpoint is checked to determine whether it is within acceptable limits. If the setpoint is not within limits, the setpoint is not used and the computer controller moves to step 416 (described below). If the setpoint is within limits, then at step 420 the computer controller 12 sets an analog output corresponding to the current row to a value proportional to the integer setpoint, e.g., a 50% setting results in a 5 volt signal on a 0-10 V analog output, and moves to step 416.

At step 416 the computer controller 12 determines whether there are more rows to evaluate. If there are additional rows to evaluate, then at step 422 the computer controller 12 proceeds to the next row and moves back to step 408 to repeat the process for the next row. If all rows have been evaluated, then the system determines whether the next time interval is active, e.g., whether there has been a transition from one time interval to the next, as shown at step 424. If the next time interval is not active, then at step 426 the computer controller 12 checks to see whether the elapsed timer 150 is stopped. If the elapsed timer 150 is stopped, then at step 428 the computer controller 12 monitors setup functions of the operator interface 90. For example, the computer controller 12 monitors setpoint entry, elapsed timer reset requests, recipe control, etc. After executing step 428, the computer controller 12 moves back to step for 426 to determine whether the elapsed timer 150 still is in a stopped condition. If the elapsed timer 150 is not stopped, then the computer controller 12 moves back to step 424 and determines whether the next time interval is active.

If the next time interval is active, e.g., a transition from one time interval to the next time interval, then at step 430 the computer controller 12 determines whether there are additional columns associated with the next time interval. If there are additional columns associated with the next time interval, then at step 432 the computer controller 12 proceeds to the next column and moves back to step 404 to repeat the process for the next time interval. If the computer controller 12 determines that all columns have been evaluated, then the computer control 12 sets all I/O points and/or actuators to logic 0 (low) and the process is complete as indicated at step 434.

The computer controller 12 described above is used to implement the methods of the invention, e.g., facilitating the setup and operation of an automated process. A person who has ordinary skill in the art of computer programming, using the flow charts provided in the drawings, may write code that a computer can execute to carry out the method for facilitating the setup and operation of an automated process.

It is noted that while the invention has been described with respect to a coating system, the invention may be used to interface and control other processes, such as a welding machine, a gluing machine, a mixing operation, etc.

While particular embodiments of the invention have been described in detail, it is understood that the invention is not limited correspondingly in scope, but includes all changes, modifications and equivalents coming within the spirit and terms of the claims appended hereto.

What is claimed is:

1. A computer controller, comprising:
a display interface;
a grid displayed on the display interface, wherein the grid includes at least one row and a plurality of columns;
a plurality of sectors on the grid, wherein each sector is formed by the intersection of the at least one row with each column;
at least one I/O point, wherein the at least one I/O point is associated with the at least one row;
a processor; wherein the processor is operatively coupled to the at least one I/O point and to the display interface;
a timer for generating a plurality of time intervals, wherein each time interval is associated with a column;
a plurality of data representing setpoints for the at least one I/O point, each setpoint being entered in a respective sector; and
a computer program executed by the processor to cause the computer controller to sequentially set the at least one I/O point to the value in a selected sector, wherein the sector is selected based on the row associated with the at least one I/O point, the time interval associated with the sector and the time interval generated by the timer.

2. The computer controller of claim 1, wherein the selected sector is identified on the grid.

3. The computer controller of claim 2, wherein the selected sector is identified by a different color shade from the unselected sectors.

4. The computer controller of claim 1, wherein the setpoint is displayed in each sector.

5. The computer controller of claim 4, wherein the color of a sector is determined from the setpoint value.

6. The computer controller of claim 1, wherein the setpoints can be stored to and retrieved from a storage medium.

7. The computer controller of claim 1, wherein the time interval is operator adjustable.

8. The computer controller of claim 1, wherein the setpoints include analog data.

9. The computer controller of claim 1, wherein the setpoints include boolean data.

10. The computer controller of claim 9, wherein at least one setpoint is configured to be mutually exclusive with at least one other setpoint.

11. The computer controller of claim 9, wherein at least one setpoint is configured to be individually inclusive with at least one other setpoint.

12. The computer controller of claim 1, wherein the at least one I/O point is a communication link between the computer controller and an actuator.

13. The computer controller of claim 12, wherein the communication link is a network interface.

14. A method for controlling a process, comprising the steps of:
displaying a grid, wherein the grid includes at least one row and a plurality of columns, and the intersection of the at least one row with each column forms a sector;
associating the at least one row with at least one I/O point;
associating each column with a time interval;
entering a setpoint in each sector;
generating a plurality of time interval signals; and
setting the at least one I/O point to the setpoint in a selected sector, wherein the sector is selected based on the row associated with the at least one I/O point, the time interval associated with the sector and the time interval signal.

15. The method of claim 14, further comprising the step of:
identifying the selected sector on the grid.

16. The method of claim 15, wherein the step of identifying the selected sector includes using a different color shade from the unselected sectors.

17. The method of claim 14, further comprising the step of:
displaying the setpoint in each sector.

18. The method of claim 17, wherein the step of displaying the setpoint includes changing the color of the sector to correspond to the setpoint value.

19. The method of claim 14, further comprising the step of:
storing and retrieving the setpoints from a storage medium.

20. The method of claim 14, further comprising the step of:
adjusting the length of the time interval.

21. The method of claim 14, wherein the step of entering setpoints includes entering analog data.

22. The method of claim 14, wherein the step of entering setpoints includes entering boolean data.

23. The method of claim 22, further comprising the step of:
designating at least one setpoint to be mutually exclusive with at least one other setpoint.

24. The method of claim 22, further comprising the step of:
designating at least one setpoint to be individually inclusive with at least one other setpoint.

25. The method of claim 14, wherein the step of setting the at least on I/O point includes establishing a communication link between the computer controller and an actuator.

26. The method of claim 25, wherein the step of establishing a communication link includes using a network interface.

25. A system for controlling a coating process, comprising:
at least one applicator for applying a coating, wherein the applicator is operatively coupled to an I/O point;
at least one supply source used by the applicator;
at least one control valve for selecting the at least one supply source used by the applicator, wherein the control valve is operatively coupled to at least one I/O point; and
a computer controller, comprising:
a display interface;
a grid displayed on the display interface, wherein the grid includes a plurality of rows and a plurality of columns;
a plurality of sectors on the grid, wherein each sector is formed by the intersection of each row with each column;
a plurality of I/O points, wherein each I/O point is associated with a row;
a processor; wherein the processor is operatively coupled to the plurality of I/O points and to the display interface;
a timer for generating a plurality of time intervals, wherein each time interval is associated with a column;
a plurality of data representing setpoints for the plurality of I/O points, each setpoint being entered in a respective sector; and
a computer program executed by the processor to cause the computer controller to sequentially set each I/O point to the value in a selected sector, wherein the sector is selected based on the row associated with each I/O point, the time interval associated with the sector and the time interval generated by the timer.
